(19) United States
(12) Patent Application Publication
(10) Pub. No.: US 2017/0183263 A1
(43) Pub. Date: Jun. 29, 2017

(54) Method for manufacturing a protective concrete weight coating for pipelines

(71) Applicant: Igor Ivanovich Shaporin, Moscow (RU)

(72) Inventor: Igor Ivanovich Shaporin, Moscow (RU)

(21) Appl. No.: 14/757,595

(22) Filed: Dec. 23, 2015

(51) Int. Cl. C04B 28/18

(52) U.S. Cl. CPC C04B 28/18

(57) ABSTRACT

A method for manufacturing a protective concrete weight coating for pipelines The invention relates to materials for application to the outer surfaces of pipes as a protective negative buoyancy coating. It allows achieving accurately a desired density of the concrete protective weight coating of the pipeline in the range of 2600 to 3400 kg/m³ by claimed method of manufacturing a protective concrete weight coating for pipelines which includes mixing cement, aggregate, a plasticizing additive and water, pumping the resultant mixture into an annular space formed by the outer surface of a pipeline and a permanent form mounted with clearance thereon, and setting the resultant coating.

### RELATED APPLICATIONS

This application claims priority to Patent Cooperation Treaty Application number PCT/RU2014/000456, filed on Jun. 26, 2014, which claims priority to Russian patent application number RU2013129182, filed on Jun. 27, 2013 and incorporated herewith by reference in its entirety.

### FIELD OF THE INVENTION

The invention relates to materials for application to the outer surfaces of pipes as a protective negative buoyancy coating.

### BACKGROUND OF THE INVENTION

There is a known method of preparing a ballast material for underwater pipelines, comprising mixing cement, aggregates, water, and plasticizer, wherein coarse aggregate from the group of barite, or iron-containing ore, or a mixture thereof is used as a aggregate. The mixing is carried out in two stages, as a first step the mentioned coarse aggregate, cement, water and plasticizer are fed to a mixer in the amount of 10 wt. % to 20 wt. % of its total amount, the mixing is performed of 10 to 15 seconds and as the second step, test of the mentioned coarse aggregate is supplied in equal portions at intervals of 10 to 15 seconds while stirring and mixing of the components is carried out until a homogeneous mixture (RU 2412393, Feb. 20, 2011).

There is a known ballast material containing cement, barite ore, water and a plasticizer. The following fractional composition of barite ore wt. % is used in the manufacture of ballast material: coarse fraction (from 5 mm to 25 mm)—8 wt. % to 16 wt. %, fine fraction (from 0.16 mm to 5 mm)—70 wt. % to 84 wt. %, a very small fraction (from 0,01 μM to 160 μM )—8 wt. % to 14 wt. % (RU 2399828, Sep. 20, 2010).

There is also known ballast material, comprising cement, aggregate, plasticizer and water. The material has sulphate resistant Portland cement, polycarboxylate PCE plasticizer, and barium product, barite and iron manganese ore aggregate concentrate. The material has the following component ratio, wt. %: Portland cement—from 8.2 wt. % to 10.5 wt. %, water—from 5.2 wt. % to 6.7 wt. %, plasticizer—from 0.1 wt. % to 0.15 wt. %, barite product—from 18 wt. % to 28 wt. % with density of 3.78 kg/cm³ to 3.82 kg/cm³ and a humidity of 0.9% to 2.1%, barite ore—from 18 wt. % to 28 wt. % with density of 3.9 kg/cm³ to 4.1 kg/cm³ and a moisture content of 2%, iron manganese concentrate—from 25 wt. % to 45 wt. % with density of 4.2 kg/cm³ to 4.5 kg/cm³ and moisture content of 4%.

The ratio of water to Portland cement is from 0.35 to 0.5. Aggregate components have the following particle size distribution: up to 0.16 cm—up to 5% from 0.16 cm to 1.0 cm—up to 25% from 1.0 cm to 2.5 cm—up to 35% from 2.5 cm to 5.0 cm—the rest (RU 2437020, Dec. 20, 2011).

Disadvantages of the above-mentioned technical solutions are insufficient viscosity of the solution and time of preserving the mobility of the concrete mixture, making it difficult to fill the annulus of “pipe in pipe” structure and making it necessary for the control of the operational raw materials humidity in order to avoid rupture of the outer shell and the bundle of concrete solution within the fulfilled structure.

The closest to the proposed technical solution is a method for manufacturing of the ballast coating on the pipe, comprising: mixing the initial components, namely, sulphate resistant Portland cement, barite ore and plasticizer based on polycarboxylate ether and water. The components for mixture are taken in the following amounts (wt. %): sulphate resistant Portland cement of 12 wt. % to 17 wt. %, water of 4 wt. % to 10 wt. %, plasticizer based on polycarboxylate ether of 0.1 wt. % to 0.25 wt. %, barite ore—the rest. And different fractions of barite ore at the following content (wt. %) are served for the mixture: large 3 mm to 25 mm—18 wt. %, fine 0.16 mm to 3 mm—of 70 wt. % to 85 wt. %, very small 0.01 mm to 0.16 mm—of 7 wt. % to 16 wt. %.

Water for concrete mixture is subject to pre-treatment by passing it through a magnetic field, wherein the intensity is maintained at the value of 120 000 A/m to 140 000 A/m, at a speed of 0.5 m/sec to 3.0 m/sec, the time of water treatment is not less than 2 hours (RU 2453515, Jun. 20, 2012).

However, the known method is rather difficult to apply to mixtures that are prone to self-packing, as the water treated in a magnetic field has a relatively small period of effective action, which imposes substantial limitations on the time of the solution feeding, and the behaviour of such concrete mixes under external forces (for example feeding of the mix with a concrete pump) could change rapidly.

### SUMMARY OF THE INVENTION

The invention relates to materials for application to the outer surfaces of pipes as a protective negative buoyancy coating. It allows achieving accurately a desired density of the concrete protective weight coating of the pipeline in the range of 2600 to 3400 kg/m³ by claimed method of manufacturing a protective concrete weight coating for pipelines which includes mixing cement, aggregate, a plasticizing additive and water, pumping the resultant mixture into an annular space formed by the outer surface of a pipeline and a permanent form mounted with clearance thereon, and setting the resultant coating. In the method, Portland cement is supplied for mixing in an amount such that the mixture contains from 8.8 wt. % to 20.0 wt. % Portland cement, and water is added in an amount such that the ratio of water to cement is from 0.31 to 0.63. The plasticizing additive, in the form of a plasticizer and a defoamer, is supplied for mixing in an amount of from 1.0 kg/m³ to 3.0 kg/m³. The aggregate supplied for mixing is selected flout barium ore or an iron-bearing ore, or gabbro-diabase, or granite with particle size not exceeding 10 mm. The resultant concrete mixture has a flow behaviour index, measured by the slump of a cone, which is equal to from 55 cm to 75 cm, and an air content of from 1% to 4% of the volume.

### DETAILED DESCRIPTION OF THE PREFERRED EMBODIMENT

The technical advantage of the claim is a method for manufacturing a protective concrete weight coating of the pipeline with high set density and with a high compressive strength after curing and aging. This in turn allows improving the technical result, namely reducing of the outer diameter of the pipe with a protective ballast coating for underwater, underground and ground use.

The claimed technical advantage is achieved by the claimed method of manufacturing a protective concrete weight coating of the pipeline, which comprises mixing cement, aggregate, plasticizing additive and water. The resulting mixture is injected into the annular space formed by the outer surface of the pipe and mounted thereon with a gap of permanent shuttering. The coat is left to age. Portland cement is supplied for mixing in an amount such that the mixture contains from 8.8 wt. % to 20.0 wt. %, water is added in an amount such that the ratio of water to cement is from 0.31 to 0.63. The plasticizing additive, in the form of a plasticizer and a defoamer, is supplied for mixing in an amount of from 1.0 kg/m³ to 3.0 kg/m³. The aggregate supplied for mixing should contain grain size not exceeding 10 mm. The aggregate is selected from barium ore or an iron-bearing ore, or gabbro-diabase, or granite. The resultant concrete mixture has a flow behaviour index, measured by the slump of a cone, which is equal to from 55 cm to 75 cm, and an air content of from 1% to 4% of the volume. For the best resulting density of the protective concrete weight coating it is preferable that the aggregate supplied for mixture has the following particle size distribution: up to 0.16 mm—up to 8%, from 0.16 mm to 1.25 mm—up to 35%, from 1.25 mm to 2.5 mm—up to 37%, from 2.5 mm to 10.0 mm—the rest.

As a plasticizer for mixture it is preferable to use lignosulfonates, naphthalene sulfonates and melamine sulfonates separately or in a mixture in any combination. The plasticizer is used in an amount of up to 1% of dry matter by weight of cement.

It is preferable that in the plasticizing additive the defoamer does not comprise more than 50% of the insertion plasticizer.

In order to obtain the necessary mobility and sufficient viscosity of mixtures, and to avoid its separation, plasticizer is chosen so that the resulting material on one hand is sufficiently fluid, namely slump flow should be between 55 cm to 75 cm, and on the other hand the content of air should be in the range from 1% to 4% of volume. Thus, in the claimed method the plasticizing additive supplied for mixture consists of a plasticizer and a defoamer in the amount of 1.0 kg/m³ to 3.0 kg/m³ which allows obtaining a plastic concrete mass which fills the entire space between the pipes and also after hardening concrete coating will have a high density. In the plasticizing additive defoamer content shall not exceed 50%. The increase of the defoamer volume leads to a sharp decrease of fluidity of the concrete mix and the appearance of voids in the concrete coating, which hinders the characteristics of the compressive strength of the concrete coating. Smaller volumes of the defoamer of less than 1% increases the air content of the concrete mix resulting in reduced concrete coating density. The ratio of water to cement, selected in the range of 0.31 to 0.63 is necessary to achieve the desired mobility and strength of the concrete material. The decrease of water volumes leads to the reduction of mobility of the concrete and the appearance of air voids after solidification, and the increase of water volumes leads to the delamination and loss of compressive strength of concrete pavement.

Below is the example of the application of the claimed method of pipeline protective concrete weight coating manufacturing by using barite ore as aggregate which does not limit the scope of the present claim.

An example of the method application. At first the preparation of the starting components of the mixture shall be carried out. The process of preparing the components of the concrete mix comprises grinding of inert aggregate, such as barite ore to a size not exceeding 10 mm. The use of larger fractions of a aggregate leads to decrease in density of the coating. If necessary, barite ore is heated to 5° C. (max), while closely observing the melting of the pieces of rock stuck together (frozen together) to prevent separation of the ballast mixture during transportation. Then the moisture content of barite ore is measured. As a result of the humidity measurement the content of barite ore in the composition of ballast material is calculated according to the formula:

m₁=m₂/(1−W/100)

where m₁ is the weight of barite ore accounting for humidity,

m₂—weight of barite ore in nominal recipe,

W—moisture content expressed as a percentage.

Barite ore is sifted through dresser to separate coarse fraction impurities. Then the barite ore and Portland cement in the amount of its content in the mixture of 8.8% to 20.0% is supplied to the scales through a conveyor system, where the components are weighed according to the specification of the structure. Particle size distribution of the aggregate is shown in Table 1, the selection of ratios is due to the production of ballast coating with a given density.

To ensure the fluidity of the concrete mix during filling the plasticizing additive is added in an amount of 1.0 kg/m³ to 3.0 kg/m³. Plasticizing additive is a mixture of plasticizer and defoamer. Moreover, the amount of the defoamer in plasticizing additive should be not more than 50%. Tributyl phosphate or self-dispersing, anhydrous Penta-4604 silicone defoamer can be used as a defoamer. Any known plasticizers, such as lignosulfonates, naphthalene sulfonates and melamine sulfonates can be used as a plasticizer. These plasticizers can be used separately or in any combination with no influence on the claimed technical result. The amount of plasticizer should be no more than 1% on dry matter by weight of cement.

The resulting mixture is added by water at the water to cement ratio from 0.31 to 0.63, and mixed thoroughly. Stirring is continued until a uniform homogeneous mixture with face breaking tapering from 55 cm to 75 cm. The resulting concrete mixture is pumped by concrete pump into the space between the carrier pipe and mounted thereon permanent shuttering. This tubular structure is assembled on the stand, set at a certain angle. The injection solution is made through a special removable plug at the end of the pipe. This design is inclined to fill in (one end lower than the other) and the filling is done through the end located below. Pumping concrete mix is carried out till the concrete pump fulfilled the structure—to yield a mixture from the nozzle of cover located above and opposite site. After completion of the filling the structure it is displayed for a soaking time until curing is not less than 5 MPa, and then stored to a set to achieve of transport strength of not less than 22 MPa.

Depending on process requirements various types of external permanent shuttering may be used during the filling of the pipe construction, for example, spiral steel shuttering locks may be performed inside and outside the construction and can be painted or coated with various polymeric materials, which allows to obtain different characteristics of products.

To reinforce the structure the arrangement of the reinforcement (steel or plastic) in the form of rods or mesh connected by welding or linked) is possible in the space between the pipe and the permanent shuttering, and to enhance the strength of the concrete it is possible to use fibers (steel or plastic).

The claimed method allows achieving accurately a desired density of the concrete protective weight coating of the pipeline in the range of 2600 to 3400 kg/m³.

Determination of the average density of the mixture is made in accordance with GOST 12730.1-78. The compressive strength is determined in accordance with GOST 10180-90.

Aggregates can be used to have coating with different characteristics in density and strength not only barite, but iron ore, gabbro-diabase, granite. These aggregates can be used separately and in various combinations. Examples of compounds used in the process and the resulting protected densities and compressive strength of the obtained coating are shown in Table 2. When used as part of a combination of different aggregates fractional content is crushed (in reparation) for each component separately. Thus, fine aggregate and coarse fractions are composed of the same components and in the proportions shown in Table 1.

The stated quantities of submitted initial components and the main characteristics of the resulting mixture have been identified in numerous field experiments, the results of which are shown in Table 1 and Table 2. Table 1 shows the particle size distribution of aggregates. The presence of the fines in the aggregate creates conditions that reduce stratification of the protective concrete weight of the material in the process of fulfilling.

Table 2 shows examples of various formulations of the protective weight coating of the pipeline components with different densities and provides compressive strength obtained for each ballast material composition, as well as data on the resulting coating according to the prototype.

TABLE 1

| Title of the component | Density kg/cm³ | Grain size, mm |
|---|---|---|
| Barite ore | from 3.7 to 4.1 | Up to 0.16 up to 8%; |
| | | from 0.16 to 1.25 up to |
| | | 35% |
| | | from 1.25 to 2.5 up to |
| | | 37% |
| | | from 2.5 to 10.0 rest |
| Iron-ore | from 3.8 to 4.5 | Up to 0.16 up to 8%; |
| | | from 0.16 to 1.25 up to |
| | | 35% |
| | | from 1.25 to 2.5 up to |
| | | 37% |
| | | from 2.5 to 10.0 rest |
| Gabbro-diabase | from 3.01 to 3.06 | Up to 0.16 up to 8%; |
| | | from 0.16 to 1.25 up to |
| | | 35% |
| | | from 1.25 to 2.5 up to |
| | | 37% |
| | | from 2.5 to 10.0 rest |
| Granite | from 2.56 to 2.62 | Up to 0.16 up to 8%; |
| | | from 0.16 to 1.25 up to |
| | | 35% |
| | | from 1.25 to 2.5 up to |
| | | 37% |
| | | from 2.5 to 10.0 rest |

TABLE 2

| Components | 1 | 2 | 3 | 4 | 5 | 6 | 7 | 8 |
|---|---|---|---|---|---|---|---|---|
| Cement, kg/m³* | 470 | 480 | 450 | 450 | 340 | 350 | 480 | 350 |
| Water, kg/m³ | 210 | 172.8 | 194 | 210 | 150 | 150 | 210 | 210 |
| Plasticizing | 1.2 | 1.92 | 1.2 | 1.3 | 2.6 | 2.6 | 1.24 | 1.2 |
| additive, kg/m³ | | | | | | | | |
| Gravel* | — | — | — | — | — | — | — | — |
| Barite ore, kg/ | — | — | — | 700 | 800 | 600 | — | 2560 |
| m³* | | | | | | | | |
| Iron-containing | — | — | — | 750 | 2060 | | 2100 | — |
| ores, kg/m³* | | | | | | | | |
| Gabbro-diabase, | 650 | — | 2230 | 950 | | 2300 | — | — |
| kg/m³* | | | | | | | | |
| Granite, kg/m³* | 990 | 1979 | — | — | | | — | — |
| Sand* | — | | — | — | — | — | — | — |
| Water-cement | 0.45 | 0.36 | 0.43 | 0.47 | 0.44 | 0.43 | 0.44 | 0.6 |
| ratio | | | | | | | | |
| The air content | 2.8 | 1.7 | 2.7 | 2.0 | 1.9 | 1.8 | 1.8 | 2.5 |
| before structure | | | | | | | | |
| fulfilling, % | | | | | | | | |
| Blurred cone, cm | 57 | 68 | 58 | 60 | 62 | 64 | 55 | 62 |
| Density, kg/m³ | 2600 | 2450 | 2800 | 3000 | 3350 | 3400 | 2800 | 3150 |
| Compressive | 48 | 74 | 48 | 51 | 49 | 48 | 42 | 47 |
| strength, MPa | | | | | | | | |

| | | | | | | | | Prototype |
|---|---|---|---|---|---|---|---|---|
| Components | 9 | 12 | 13 | 14 | 13 | 14 | 15 | content |
| Cement, kg/m³* | 430 | 430 | 430 | 450 | 460 | 460 | 420 | 420 |
| Water, kg/m³ | 210 | 210 | 200 | 200 | 210 | 210 | 210 | 190 |
| Plasticizing additive, | 1.3 | 2.1 | 1.8 | 1.9 | 2.1 | 1.4 | 2.6 | — |
| kg/m³* | | | | | | | | |
| Gravel* | | | | — | | | | 1140 |
| Barite ore, kg/m³* | 600 | | | 500 | 500 | 500 | | — |
| Iron-containing ores, | | 2050 | 2000 | 900 | 900 | | 1500 | — |
| kg/m³* | | | | | | | | |
| Gabbro-diabase, | | 560 | | 650 | | 1230 | 500 | |
| kg/m³* | | | | | | | | |
| Granite, kg/m³* | 1300 | | 520 | 300 | 800 | 300 | 370 | |
| Sand* | | | | — | | | | 710 |
| Water-cement ratio | 0.49 | | | | | | | 0.45 |
| The air content before | 2.5 | 2.5 | 2.5 | 2.5 | 2.5 | 2.5 | 2.5 | |
| structure fulfilling, % | | | | | | | | |
| Blurred cone, cm | 55 | 56 | 54 | 65 | 60 | 56 | 55 | |
| Density, kg/m³ | 2540 | 3250 | 3250 | 3000 | 2870 | 2700 | 3000 | 2480 |
| Compressive strength, | 47 | 47 | 48 | 60 | 55 | 56 | 46 | 45 |
| MPa | | | | | | | | |

*The presented data are shown in the table on a dry matter basis.

While the invention has been described with reference to an exemplary embodiment, it will be understood by those skilled in the art that various changes may be made and equivalents may be substituted for elements thereof without departing from the scope of the invention. In addition, many modifications may be made to adapt a particular situation or material to the teachings of the invention without departing from the essential scope thereof. Therefore, it is intended that the invention not be limited to the particular embodiment disclosed as the best mode contemplated for carrying out this invention, but that the invention will include all embodiments falling within the scope of the appended claims.

1. A method for manufacturing a protective concrete weight coating for pipelines said method comprising the steps of:
mixing cement, aggregate, a plasticizing additive and water, wherein lignosulfonates, melamine sulfonates and naphthalene sulfonates are applied as the mixture plasticizer separately;
pumping the resultant mixture the cement, aggregate, the plasticizing additive and the water into an annular space formed by the outer surface of a pipeline and a permanent form mounted with clearance thereon, and setting the resultant costing, wherein a portland cement is supplied for mixing in an amount such that the mixture contains from 8.8 wt. % to 20.0%, water is added in an amount such that the ratio of water to cement is from 0.31 to 0.63, the plasticizing additive, in the form of a plasticizer and a defoamer, is supplied for mixing in an amount of from 1.0 kg/m³ to 3.0 kg/m³ , the aggregate supplied for mixing is selected from barium ore or an iron-bearing ore, or gabbro-diabase, or granite, with particle size not exceeding 10 mm, the resultant concrete mixture has a flow behaviour index, measured by the slump of a cone, which is equal to from 55 cm to 75 cm, and an air content of from 1% to 4% of the volume, and the aggregate of mixture has the following particle size distribution:
up to 0.16 mm—up to 8%,
from 0.16 mm to 1.25 mm—up to 35%,
from 1.25 mm to 2.5 mm—up to 37%,
from 2.5 mm to 10.0 mm—the rest.

2. (canceled)

3. The method as set forth in claim 1 wherein the plasticizer is used in an amount of up to 1% of dry matter by weight of cement.

4. The method as set forth in claim I wherein the plasticizing additive defoamer is less than 50% by weight.
